(19) United States
(12) Patent Application Publication
(10) Pub. No.: US 2009/0289881 A1
(43) Pub. Date: Nov. 26, 2009

(54) Power circuit and liquid crystal display device

(75) Inventors: Jie-Jian Zheng, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/454,874

(22) Filed: May 26, 2009

(30) Foreign Application Priority Data
May 23, 2008 (CN) 200810067422.5

(51) Int. Cl. G09G 3/36; H02J 3/00

(52) U.S. Cl. 345/87; 307/31

(57) ABSTRACT

A power circuit includes a transformer, a full-bridge rectifier and a feedback circuit. The transformer is used to input an external AC voltage. The transformer includes a plurality of output terminals. The output terminals include a plurality of output terminal combinations, and at least two different output terminal combinations output a first AC voltage and a second AC voltage. The full-bridge rectifier is used to convert the first AC voltage or the second AC voltage into DC voltages. The feedback circuit makes the transformer switch between different output ports combinations according to the value of the second AC voltage.

### BACKGROUND

1. Technical Field

The present disclosure relates to a power circuit and a liquid crystal display device using the same.

2. Description of Related Art

Liquid crystal display (LCD) devices are widely used in various devices, such as computers, personal digital assistant (PDAs), and TVs. An LCD device often includes a power circuit electrically connected to an external alternating current (AC) power source to supply the device with direct current (DC) voltage. Such voltages, however, are unstable as the source AC voltage is unstable. The unstable voltages can damage components of the device.

As shown in FIG. 2, a commonly used LCD device 20 includes a power circuit 25 and a driving circuit 26. The power circuit 25 supplies the driving circuit 26 with DC voltage. The power circuit 25 includes a transformer 21, a full-bridge rectifier 22, and a filter capacitor 24. The transformer 21 includes a primary winding and a secondary winding. The transformer 21 receives an external AC voltage from an external AC power source through the primary winding. The secondary winding includes two output terminals 211, 212. An AC voltage is output from the two output terminals 211, 212. The AC voltage is converted to DC voltage by the full-bridge rectifier 22. The full-bridge rectifier 22 includes two input terminals 221, 222 and two output terminals 223, 224. The two input terminals 221, 222 are electrically connected to the two output terminals 211, 212 of the transformer 21, respectively. The two output terminals 223, 224 are electrically connected to the driving circuit 26 and are electrically connected to each other through the filter capacitor 24. The filter capacitor 24 stabilizes the DC voltage output from the full-bridge rectifier 22.

However, the DC voltage output from the power circuit 25 changes with the external AC voltage. As the external AC voltage is unstable, the DC voltage output from the power circuit 25 is unstable. The unstable DC voltage makes the driving circuit 26 work abnormally or even damage components of the driving circuit 26.

What is needed, is a power circuit and an LCD device that can over come the above-described deficiencies.

### BRIEF DESCRIPTION OF THE DRAWINGS

The components in the drawings are not necessarily drawn to scale, the emphasis instead being placed upon clearly illustrating the principles of the present power circuit and the LCD device. In the drawings, like reference numerals designate corresponding parts throughout various views, and all the views are schematic.

FIG. 1 is a schematic circuit diagram of an LCD device according to an embodiment of the present disclosure.

FIG. 2 is a schematic circuit diagram of an LCD device.

### DETAILED DESCRIPTION

Reference will now be made to the drawings to describe exemplary embodiments of the present disclosure in detail.

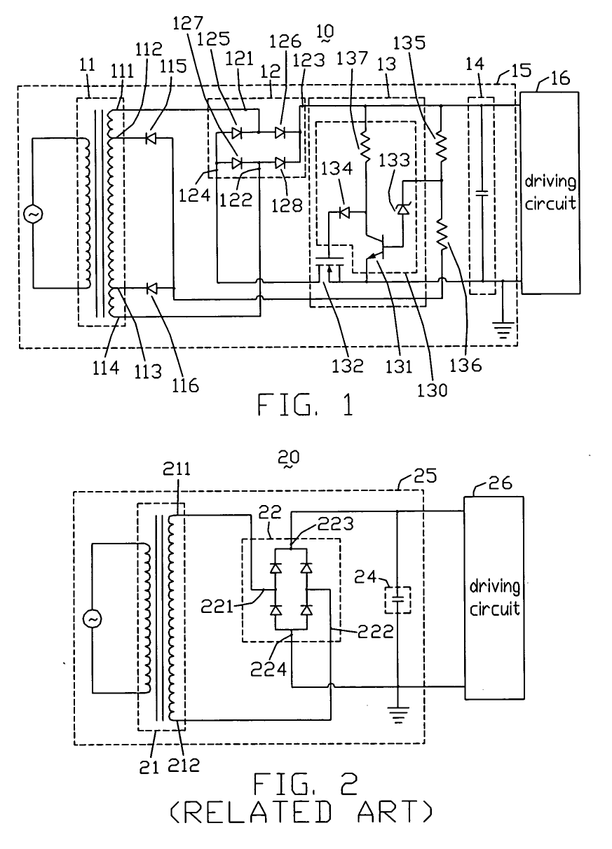

FIG. 1 is a schematic circuit diagram of an LCD device 10 according to an embodiment of the present disclosure. The LCD device 10 includes a power circuit 15 and a driving circuit 16. The power circuit 15 supplies the driving circuit 16 with DC voltage.

The power circuit 15 includes a transformer 11, a full-bridge rectifier 12, a feedback circuit 13, a filter capacitor 14, two diodes 115, 116, and a voltage divider which includes two resistors 135, 136 connected in series. The transformer 11 includes a primary winding and a secondary winding. The transformer 11 receives an external AC voltage from an external AC power source through the primary winding. The secondary winding includes a first output terminal 111, a second output terminal 112, a third output terminal 113, and a fourth output terminal 114. Every two output terminals of the four output terminals 111, 112, 113, 114 define an output terminal combination, so the four output terminal 111, 112, 113, 114 define a first output terminal combination including the first and the fourth output terminals 111, 114, a second output terminal combination including the first and the third output terminals 111, 113, and a third output terminal combination including the second and the fourth outpour terminals 112, 114 in total. The number of turns of the second output terminal combination is the same as the number of turns of the third output terminal combination, and less than the number of turns of the first output terminal combination.

The full-bridge rectifier 12 converts AC voltage from the transformer 11 to DC voltage. The full-bridge rectifier 12 includes a first input terminal 121, a second input terminal 122, a positive output terminal 123, a negative output terminal 124, a first diode 125, a second diode 126, a third diode 127, and a fourth diode 128. A cathode of the first diode 125 and an anode of the second diode 126 are electrically connected to the first input terminal 121. Anodes of the first and third diodes 125, 127 are electrically connected to the negative output terminal 124. A cathode of the third diode 127 and an anode of the fourth diode 128 are electrically connected to the second input terminal 122. Cathodes of the second and fourth diodes 126, 128 are electrically connected to the positive output terminal 123. The first input terminal 121 is electrically connected to the output terminal 111 of the transformer 11. The second input terminal 122 is electrically connected to the fourth output terminal 114 of the transformer 11. The positive output terminal 123 is electrically connected to the second output terminal 112 through the voltage divider, an anode and a cathode of diode 115 in that order. An anode of the diode 116 is electrically connected to the anode of the diode 115, and a cathode of the diode 116 is electrically connected to the third output terminal 113.

The feedback circuit 13 includes a comparator 130 and a switch 132. The comparator 130 includes a bipolar transistor 131, a diode 134, a zener diode 133, and a resistor 137. The switch 132 is a field effect transistor, The field effect transistor is an NMOS transistor, and the bipolar transistor 131 is an npn bipolar transistor. A base of the bipolar transistor 131 is electrically connected to a node between the two resistors 135, 136 through an anode and a cathode of the zener diode 133. A collector of the bipolar transistor 131 is electrically connected to the positive output terminal 123 of the full-bridge rectifier 12 through the resistor 137. An emitter of the bipolar transistor 131 is electrically connected to ground. A source of the field effect transistor is electrically connected to the emitter of the bipolar transistor 131. A gate of the field effect transistor is electrically connected to the collector of the bipolar transistor 131 through an anode and a cathode of the diode 134. A drain of the field effect transistor is electrically connected to the negative output terminal 124.

An end of the filter capacitor 14 is electrically connected to the positive output terminal 123 of the full-bridge rectifier 12, and another end of the filter capacitor 14 is electrically connected to the source of the field effect transistor. As the output AC voltage of the transformer 11 keeps steady, a steady DC voltage with predetermined voltage value is generated between the two ends of the filter capacitor 14. The driving circuit is electrically connected to the two ends of the filter capacitor 14 and drives an LCD panel.

Operation of the LCD device 10 follows:

An external AC voltage is transformed by the transformer 11 to an AC voltage with value lower than that of the external AC voltage, such as an AC voltage of 20 V or an AC voltage of 22 V. The AC voltage is proportional to the external AC voltage and changes with the external AC voltage. When the AC voltage is rectified by the full-bridge rectifier 12 and the two diodes 115, 116, a positive voltage is output from the positive output terminal 123 of the full-bridge rectifier 12 and a negative voltage is output from the negative output terminal 124 of the full-bridge rectifier 12, the second output terminal 112, and the third output terminal 113.

The voltage value between the two ends of the filter capacitor 14 is equal to that between the positive output terminal 123 of the full-bridge rectifier 12 and ground. The value of positive voltage output from the positive output terminal 123 is proportional to the value of the positive voltage output from the first output terminal 111 or the fourth output terminal 114. The value of the positive voltage output from the first output terminal 111 or the fourth output terminal 114 changes as different output terminal combination is used, and is proportional to the external AC voltage. The first output terminal combination outputs a first AC voltage. The second output terminal combination or the third output terminal combination outputs a second AC voltage. As the value of the output AC voltage is proportional to the number of turns of the output terminal combination, the value of the first AC voltage is greater than that of the second AC voltage.

The zener diode 133 defines a predetermined voltage value, such as a value of 19 V. As the second voltage changes with the external AC voltage, when the value of second AC voltage is greater than the predetermined voltage value, a higher voltage is applied to the zener diode 133, which is then turned on. The higher voltage is applied to the base of the bipolar transistor 131 through the zener diode 133 and the bipolar transistor 131 is turned on. The gate of the field effect transistor is electrically connected to ground. A lower voltage is applied to the gate of the field effect transistor, the field effect transistor is turned off. When a positive voltage is output from the first output terminal 111, the voltage generated by the secondary winding outputs from the second output terminal combination to the full-bridge rectifier 12. When a positive voltage is output from the fourth output terminal 114, the voltage generated by the secondary winding outputs from the third output terminal combination to the full-bridge rectifier 12. The transformer 11 thus outputs the second AC voltage to the full-bridge rectifier 12. Thus, when the value of the second AC voltage is greater than the predetermined voltage value, the power circuit 15 outputs a DC voltage with correspondingly lower value.

When the value of second AC voltage is lower than the predetermined voltage value, a lower voltage is applied to the zener diode 133 so as to turn off the zener diode 133. The bipolar transistor 131 is turned off as the zener diode 133 is turned off. A higher voltage is applied to the gate of the field effect transistor through the resistor 137 and the diode 134. The field effect transistor is turned on. The voltage generated by the secondary winding outputs from the first output terminal combination to the full bridge rectifier 12. The transformer 11 outputs the first AC voltage. Thus, when the value of the second AC voltage is lower than the predetermined voltage value, the power circuit 15 outputs a DC voltage with correspondingly higher value.

In summary, the power circuit 15 includes a transformer 11 with a plurality of output terminals and a feedback circuit 13. The transformer 11 is controlled by the feedback circuit 13 according to the second AC voltage. The transformer 11 outputs a first AC voltage to the full-bridge rectifier 12 through the first output terminal combination when the value of the second AC voltage is lower than a predetermined voltage value. The transformer 11 outputs a second AC voltage to the full-bridge rectifier 12 through the second output terminal combination, or the third output terminal combination when the value of the second AC voltage is greater than a predetermined voltage value. Thus, the output DC voltage of the power circuit 15 is relatively steady. The power circuit 15 is applied to the LCD device 10, and provided the driving circuit 16 with steady DC voltage. The LCD device 10 with the power circuit 15 works steadily as well.

In alternative embodiments, the switch 132 can be an npn bipolar transistor and the bipolar transistor 131 can be replaced by an NMOS transistor.

In addition, the gate of the field effect transistor can be generalized as a control terminal, the source of the field effect transistor can be generalized as a first terminal, and the drain of the field effect transistor can be generalized as a second terminal.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of the present disclosure to the full extent indicated by the broad general meaning of the terms in which the appended claims are expressed.

What is claimed is:

1. A power circuit, comprising:
a transformer comprising:
a plurality of output terminals, the plurality of output terminals defining at least a first output terminal combination and a second output combination, a value of an alternating current (AC) voltage output from the first output terminal combination differing from a value of an alternating current (AC) voltage output from the second output terminal combination,
a full-bridge rectifier to convert AC voltage into direct current (DC) voltage, and
a feedback circuit to control the full-bridge rectifier to receive the AC voltage output from the first output terminal combination or the second output combination according to the AC voltage output from the second output combination.

2. The power circuit of claim 1, wherein the plurality of output terminals comprises a first output terminal, a second output terminal, a third output terminal, and a fourth terminal, the first output terminal combination comprising the first and the fourth output terminals, the second output terminal combination comprising the first and the third output terminals or comprising the second and the fourth output terminals.

3. The power circuit of claim 2, wherein a first AC voltage is output from the first output terminal combination; and a second AC voltage is output from the second output terminal combination, the value of the first AC voltage being greater than the value of the second AC voltage.

4. The power circuit of claim 2, wherein a number of turns of the second output terminal combination is less than the number of turns of the first output terminal combination.

5. The power circuit of claim 2 further comprising a voltage divider, the full-bridge rectifier comprising a first input terminal, a second input terminal, a positive output terminal, and a negative output terminal, the first input terminal being electrically connected to the first output terminal of the transformer, the second input terminal being electrically connected to the fourth output terminal of the transformer, the positive output terminal being electrically connected to the second and the third output terminals of the transformer through the voltage divider, and the negative output terminal being electrically connected to ground through the feedback circuit.

6. The power circuit of claim 5, wherein the voltage divider outputs a controlling voltage, the feedback circuit to receive the controlling voltage.

7. The power circuit of claim 6, wherein the feedback circuit comprises a comparator and a switch, the comparator to receive the controlling voltage and control the switch, and the negative output terminal being electrically connected to ground through the switch.

8. The power circuit of claim 7, wherein the comparator comprises a bipolar transistor to control the switch, and a zener diode to control the bipolar transistor, the zener diode defining a predetermined voltage value, the zener diode receiving the controlling voltage, when the controlling voltage is greater than the predetermined voltage value, the bipolar transistor being turned on, and the switch being turned off as the bipolar being turned on.

9. The power circuit of claim 5 further comprising two diodes, cathodes of the two diodes being electrically connected to the second and the third output terminals of the transformer, respectively, anodes of the two diodes being electrically connected to each other and electrically connected to the positive output terminal of the full-bridge rectifier through the voltage divider.

10. A power circuit, comprising:
a transformer to transform an external alternating current (AC) voltage into a first AC voltage and a second AC voltage, the value of the first AC voltage being greater than the value of the second AC voltage, and
a full-bridge rectifier, when the value of the second AC voltage is greater than a predetermined voltage value, the full-bridge rectifier converts the second AC voltage to a DC voltage, and when the value of the second AC voltage is lower than a predetermined voltage value, the full-bridge rectifier converts the first AC voltage to a DC voltage.

11. The power circuit of claim 10 further comprising a feedback circuit directing the transformer to output the first AC voltage or the second AC voltage to the full-bridge rectifier according to the value of the second AC voltage.

12. The power circuit of claim 11, wherein the plurality of output terminals comprises a first output terminal, a second output terminal, a third output terminal, and a fourth terminal, a first output terminal combination comprising the first and the fourth output terminals, a second output terminal combination comprising the first and the third output terminal or comprising the second and the fourth output terminals, the first AC voltage being output from the first output terminal combination, the second AC voltage being output from the second output terminal combination.

13. The power circuit of claim 11, wherein a number of turns of the second output terminal combination is less than number of turns of the first output terminal combination.

14. The power circuit of claim 11 further comprising a voltage divider, the full-bridge rectifier comprising a first input terminal, a second input terminal, a positive output terminal, and a negative output terminal, the first input terminal being electrically connected to the first output terminal of the transformer, the second input terminal being electrically connected to the fourth output terminal of the transformer, the positive output terminal being electrically connected to the second and the third output terminals of the transformer through the voltage divider, the negative output terminal being electrically connected to ground through the feedback circuit.

15. The power circuit of claim 14, wherein the voltage divider outputs a controlling voltage, the feedback circuit receiving the controlling voltage.

16. The power circuit of claim 15, wherein the feedback circuit comprises a comparator and a switch, the comparator receiving the controlling voltage and controlling the switch, the negative output terminal being electrically connected to ground through the switch.

17. The power circuit of claim 16, wherein the comparator comprises a bipolar transistor to control the switch, and a zener diode to control the bipolar transistor, the zener diode defining a predetermined voltage value, the zener diode receiving the controlling voltage, when the controlling voltage is greater than the predetermined voltage value, the bipolar transistor being turned on, and the switch being turned off as the bipolar being turned on.

18. The power circuit of claim 17, wherein the switch is an NMOS transistor.

19. The power circuit of claim 14 further comprising two diodes, cathodes of which are electrically connected to the second and the third output terminals of the transformer, respectively, anodes of the two diodes being electrically connected to each other, and electrically connected to the positive output terminal of the full-bridge rectifier through the voltage divider.

20. A liquid crystal display (LCD) device, comprising:
a driving circuit, and
a power circuit to provide the driving circuit with direct current (DC) voltage, the power circuit comprising:
a transformer to transform an external alternating current (AC) voltage into a first AC voltage and a second AC voltage, the value of the first AC voltage being greater than the value of the second AC voltage, and
a full-bridge rectifier, when the value of the second AC voltage is greater than a predetermined voltage value, the full-bridge rectifier converts the second AC voltage to a DC voltage, and when the value of the second AC voltage is lower than a predetermined voltage value, the full-bridge rectifier converts the first AC voltage to a DC voltage.
